(19) United States
(12) Patent Application Publication
(10) Pub. No.: US 2019/0342185 A1
(43) Pub. Date: Nov. 7, 2019

(54) ANALYTICS WIDGET CREATION IN GUIDED WORKFLOW

(71) Applicant: ServiceNow, Inc., Santa Clara, CA (US)

(72) Inventors: Robert-Jan Barmentloo, Leiden (NL); Benedetto Fiorelli, Amsterdam (NL); Josip Filipovic, Amsterdam (NL); Georgi Ivanov, Amstelveen (NL); Aida Rikovic Tabak, Amsterdam (NL); Elliot Monifi, Amsterdam (NL)

(21) Appl. No.: 15/969,606

(22) Filed: May 2, 2018

(51) Int. Cl. H04L 12/24; G06F 17/30; G06F 9/451; G06F 3/0482; G06T 11/20; G06F 3/0481

(52) U.S. Cl. CPC H04L 41/22; G06F 17/30572; G06F 9/453; G06T 2200/24; G06T 11/206; G06F 3/04817; G06F 3/0482

(57) ABSTRACT

Systems and methods for generating analytics widgets using a graphical user interface (GUI) are provided. The analytics widgets are generated using a visually guided workflow presented via the GUI in which attributes relating to the analytics widgets are specified at the same time the analytics widget and its associated data visualization are generated.

### BACKGROUND

The present disclosure relates generally to systems and methods for managing and visualizing databases. More specifically, the present disclosure is related to systems and methods that provide interactive generation of visual reports from databases including time series data.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Computer resources hosted in distributed computing (e.g., cloud-computing) environments may be disparately located with different resources potentially having their own functions, properties, and/or permissions. Such resources may include hardware resources (e.g. computing devices, switches, etc.) and software resources (e.g. database applications). These resources may be used to collect and store data at various times related to a variety of measurable properties, including network, hardware, or database performance properties measured at different times. As systems for collecting data become more readily available and the costs for storage hardware continue to decrease, the amount of data that these computer resources are capable of collecting is increasing. For instance, in addition to collecting raw data more frequently, metadata associated with the time in which the raw data has been generated or acquired may also be stored for a given data set.

Although the capabilities of computer resources for collecting and storing data continue to expand, the vast amount of collected data may be difficult or burdensome analyze and meaningfully evaluate or report on.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Information Technology (IT) networks may include a number of computing devices, server systems, databases, and the like that generate, collect, and store information. As increasing amounts of data representing vast resources become available, it becomes increasingly difficult to analyze the data, interact with the data, and/or provide reports for the data. The current embodiments enable customized widgets to be generated for such data, enabling a visualization of certain indicators for the data for rapid and/or real-time monitoring of the data.

For example, in an embodiment, a system configured to create analytics widgets in a guided widget creation workflow is associated with a computational instance of a remote platform that remotely manages a managed network. The system includes a database containing analytics data associated with the managed network, the analytics data defining indicators or metrics. The remote platform is configured to present a portion of the computational instance on a graphical user interface (GUI) via a display connected to a computing device having access to the computational instance, and the portion of the computational instance displayed via the GUI includes a widget creation process configured to create the analytics widgets each having a data visualization. To accomplish this, the widget creation process uses the analytics data and the indicators or metrics from the database, and causes a first section of the GUI rendered on the display to include a plurality of buttons coupled with one another to define the guided widget creation workflow. Each button of the plurality of buttons is configured to cause a respective set of attribute input fields to be displayed in response to a selection input, the respective set of attribute input fields being configured to receive user inputs to specify attributes associated with the data visualization. The widget creation process also causes a second section of the GUI rendered on the display proximate to the first section to present the data visualization in response to inputs received via the guided widget creation workflow.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of a generalized distributed computing system utilizing a cloud service type platform and databases, in accordance with an embodiment;

FIG. 2 is a block diagram of a computing device utilized in the distributed computing system of FIG. 1, in accordance with an embodiment;

FIG. 3 is a block diagram illustrating performance analytics and reporting features facilitated through a homepage and/or dashboard, in accordance with an embodiment;

FIG. 4 is an illustration of a graphical-user-interface (GUI) for facilitating generation of analytics and/or reporting widgets on a homepage/dashboard, in accordance with an embodiment;

FIGS. 5 and 6 are illustrations of a GUI for facilitating presentation of a portion of a guided widget creation workflow, the portion being used to define data sources for generating a widget, in accordance with an embodiment;

FIGS. 7-10 are illustrations of a GUI for facilitating presentation of another portion of the guided widget creation workflow, the portion being used to define the type of chart to be rendered for the widget, in accordance with certain embodiments;

FIGS. 11 and 12 are illustrations of a GUI for facilitating presentation of yet another portion of a guided widget creation workflow, the portion being used to define data configurations for generating a widget, in accordance with an embodiment;

FIGS. 13-16 are illustrations of a GUI for facilitating presentation of another portion of the guided widget creation workflow, the portion being used to define styling of various portions of the chart rendered for the widget, in accordance with certain embodiments;

FIG. 17 is an illustration of a GUI for facilitating actions to be performed with the widget, in accordance with an embodiment;

FIG. 18 is an illustration of a GUI for facilitating a dashboard destination prompt to add the widget to a homepage, in accordance with an embodiment;

FIG. 19 is an illustration of a GUI for facilitating a dashboard destination prompt to add the widget to a dashboard, in accordance with an embodiment; and

FIG. 20 is an illustration of a GUI of a plurality of time-series analytics widgets disposed on a dashboard, in accordance with an embodiment.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The following discussion relates to analysis, forecasting, and reporting systems for Information Technology (IT) systems. However, this is not meant to limit the current techniques to IT systems. Indeed, the current techniques may be useful in a number of different contexts. For example the current techniques may be applied to Human Resources (HR) systems, enterprise systems, or any system that may benefit from the analysis, forecasting, and reporting of data.

Keeping this in mind, the discussion now turns to an Information Technology (IT)-centered example. IT devices are increasingly important in a world in which various electronics devices are interconnected within a distributed context. As more functions are performed by services using some form of distributed computing, the complexity of IT network management increases. As management complexities increase, data analysis, forecasting, and reporting may become more complex.

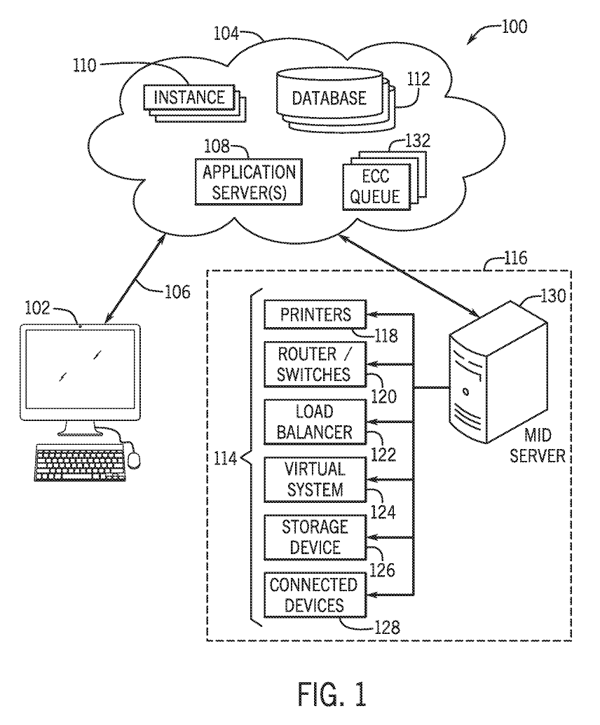

By way of introduction to the present concepts and to provide context for the examples discussed herein, FIG. 1 is a block diagram of a system 100 that utilizes a distributed computing framework, which may perform one or more of the techniques described herein. As illustrated in FIG. 1, a client 102 communicates with a platform 104, such as a cloud service platform, over a communication channel 106. The client 102 may include any suitable computing device, such as a computing system. For instance, the client 102 may include one or more computing devices such as a mobile phone, a tablet computer, a laptop computer, a notebook computer, a desktop computer, or any other similar device or combination of similar devices. The client 102 may include client application programs running on the computing devices. The client 102 can be implemented using a single physical unit or a combination of physical units (e.g., distributed computing) running one or more client application programs. Furthermore, in some embodiments, a single physical unit (e.g., server) may run multiple client application programs simultaneously.

The platform 104 may include any suitable number of configurable items (e.g., computers, applications, physical and/or virtual servers) in one or more locations that are connected together using one or more networks. For instance, the platform 104 may include various computers acting as servers in datacenters at one or more geographic locations where the computers communicate using network and/or Internet connections. The communication channel 106 may include any suitable communication mechanism for electronic communication between the client 102 and the platform 104. The communication channel 106 may incorporate local area networks (LANs), wide area networks (WANs), virtual private networks (VPNs), cellular networks (e.g., long term evolution networks), and/or other network types for transferring data between the client 102 and the platform 104. For example, the communication channel 106 may include an Internet connection when the client 102 is not on a local network common with the platform 104. Additionally or alternatively, the communication channel 106 may include network connection sections when the client and the platform 104 are on different networks or entirely using network connections when the client 102 and the platform 104 share a common network. Although only a single client 102 is shown connected to the platform 104, it should be noted that the platform 104 may connect to multiple clients (e.g., tens, hundreds, or thousands of clients).

Through the platform 104, here a cloud service type platform, the client 102 may connect to various devices with various functionality, such as gateways, routers, load balancers, databases, application servers running application programs on one or more nodes, or other devices that may be accessed via the platform 104. For example, the client 102 may connect to an application server 108 and/or one or more databases 112 via the platform 104. The application server 108 may include any computing system, such as a desktop computer, laptop computer, server computer, and/or any other computing device capable of providing functionality from an application program to the client 102. The application server 108 may include one or more application nodes running application programs whose functionality is provided to the client 102 via the platform 104. The application nodes may be implemented using processing threads, virtual machine instantiations, or other computing features of the application server 108. Moreover, the application nodes may store, evaluate, or retrieve data from the databases 112 and/or a database server. Indeed, certain embodiments of the platform 104 may run a multi-instance architecture in which a computational instance 110 (referred to for simplicity as an “instance”) runs its own application logic and database processes for each client 102.

The databases 112 may contain a series of tables containing information about assets and enterprise services controlled by a client 102 and the configurations of these assets and services. The assets and services include configuration items (CIs) 114 that may be computers, other devices on a network 116 (or group of networks), software contracts and/or licenses, or enterprise services. In certain embodiments, the network 116 may be a managed network, which is managed by the platform 104. The CIs 114 may include hardware resources (such as server computing devices, client computing devices, processors, memory, storage devices, networking devices, or power supplies); software resources (such as instructions executable by the hardware resources including application software or firmware); virtual resources (such as virtual machines or virtual storage devices); and/or storage constructs (such as data files, data directories, or storage models). As such, the CIs 114 may include a combination of physical resources or virtual resources. For example, the illustrated embodiment of the CIs 114 includes printers 118, routers/switches 120, load balancers 122, virtual systems 124, storage devices 126, and/or other connected devices 130. The other connected devices 130 may include clusters of connected computing devices or functions such as data centers, computer rooms, databases, or other suitable devices. The databases 112 may include information related to CIs 114, attributes (e.g., roles, characteristics of elements, etc.) associated with the CIs 114, and/or relationships between the CIs 114.

In some embodiments, the databases 112 may include a configuration management database (CMDB) that may store the data concerning CIs 114 mentioned above along with data related to various IT assets that may be present within the network 112. In addition to the databases 112, the platform 104 may include one or more other database servers. The database servers are configured to store, manage, or otherwise provide data for delivering services to the client 102 over the communication channel 106. The database server may include one or more additional databases that are accessible by the application server 108, the client 102, and/or other devices external to the additional databases. By way of example, the additional databases may include a relational database and/or a time series database. The additional databases may be implemented and/or managed using any suitable implementations, such as a relational database management system (RDBMS), a time series database management system, an object database, an extensible markup language (XML) database, a configuration management database (CMDB), a management information base (MIB), one or more flat files, and/or or other suitable non-transient storage structures. In some embodiments, more than a single database server may be utilized. Furthermore, in some embodiments, the platform 104 may have access to one or more databases external to the platform 104 entirely.

In the depicted topology, access to the CIs 114 from the platform 104 is enabled via a management, instrumentation, and discovery (MID) server 130 via a communication queue 132 (e.g., an External Communications Channel (ECC) queue). The MID server 130 may include an application program (e.g., Java application) that runs as a service (e.g., Windows service or UNIX daemon) that facilitates communication and movement of data between the platform 104 and external applications, data sources, and/or services. The MID service 126 may be executed using a computing device (e.g., server or computer) on the network 112 that communicates with the platform 104. As discussed below, the MID server 130 may periodically or intermittently use discovery probes to determine information on devices connected to the network 112 and return the probe results back to the platform 104. In the illustrated embodiment, the MID server 130 is located inside the network 112 thereby alleviating the use of a firewall in communication between the CIs 114 and the MID server 130. However, in some embodiments, a secure tunnel may be generated between an embodiment of the MID server 130 running in the platform 104 that communicates with a border gateway device of the network 112.

The communication queue 132 may be a database table that is typically queried, updated, and inserted into by other systems. Each record in the ECC queue 132 is a message from one of the instances 130 in the platform 104 to a system (e.g., MID server 130) external to the platform 104 that connects to the platform 104 (or a specific instance 130 running in the platform 104), or a message to the instance 130 from the external system. The fields of an ECC queue 132 record include various data about the external system or the message in the record.

Although the system 100 is described as having the application servers 108, the databases 112, the ECC queue 132, the MID server 130, and the like, it should be noted that the embodiments disclosed herein are not limited to the components described as being part of the system 100. Indeed, the components depicted in FIG. 1 are merely provided as example components and the system 100 should not be limited to the components described herein. Instead, it should be noted that other types of server systems (or computer systems in general) may communicate with the platform 104 in addition to the MID server 130 and/or may be used to implement the present approach.

Further, it should be noted that server systems described herein may communicate with each other via a number of suitable communication protocols, such as via wired communication networks, wireless communication networks, and the like. In the same manner, the client 102 may communicate with a number of server systems via a suitable communication network without interfacing its communication via the platform 104.

In addition, other methods for populating the databases 112 may include directly importing the CIs or other entries from an external source, manual import by users entering CIs or other entries via a user interface, and the like. Moreover, although the details discussed above are provided with reference to the CMDB, it should be understood that the embodiments described herein should not be limited to being performed with the CMDB. Instead, the present systems and techniques described herein may be implemented with any suitable database.

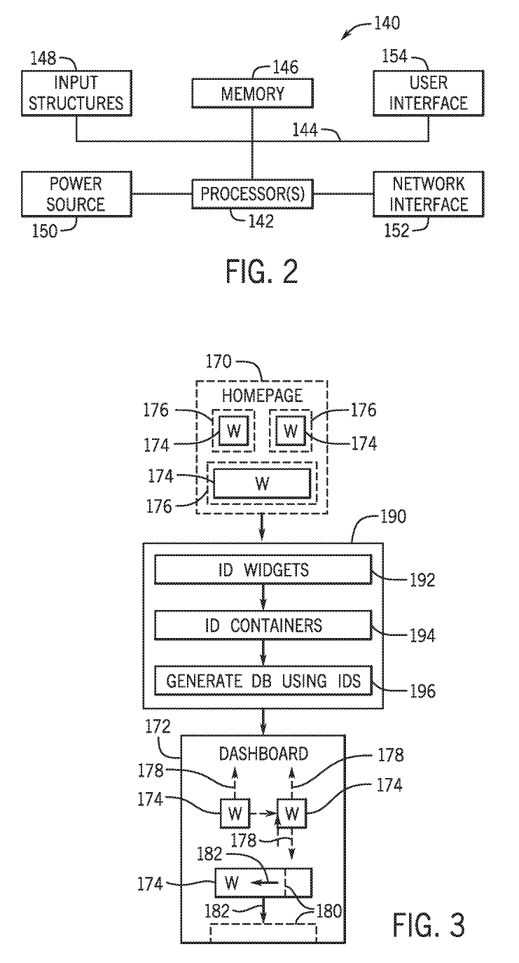

To perform one or more of the operations described herein, the client 102, the application server 108, the MID server 130, and other server or computing system described herein may include one or more of the computer components depicted in FIG. 2. FIG. 2 generally illustrates a block diagram of example components of a computing device 140 and their potential interconnections or communication paths, such as along one or more busses. As briefly mentioned above, the computing device 140 may be an embodiment of the client 102, the application server 108, a database server (e.g., databases 112), other servers or processor-based hardware devices present in the platform 104 (e.g., server hosting the communication channel queue 132), a device running the MID server 130, and/or any of the CIs 114. As previously noted, these devices may include a computing system that includes multiple computing devices and/or a single computing device, such as a mobile phone, a tablet computer, a laptop computer, a notebook computer, a desktop computer, a server computer, and/or other suitable computing devices.

As illustrated, the computing device 140 may include various hardware components. For example, the device includes one or more processors 142, one or more busses 144, memory 146, input structures 148, a power source 150, a network interface 152, a user interface 154, and/or other computer components useful in performing the functions described herein.

The one or more processors 142 may include processors capable of performing instructions stored in the memory 146. For example, the one or more processors may include microprocessors, system on a chips (SoCs), or any other suitable circuitry for performing functions by executing instructions stored in the memory 146. Additionally or alternatively, the one or more processors 142 may include application-specific integrated circuits (ASICs), field-programmable gate arrays (FPGAs), and/or other devices designed to perform some or all of the functions discussed herein without calling instructions from the memory 146. Moreover, the functions of the one or more processors 142 may be distributed across multiple processors in a single physical device or in multiple processors in more than one physical device. The one or more processors 142 may also include specialized processors, such as a graphics processing unit (GPU).

The one or more busses 144 includes suitable electrical channels to provide data and/or power between the various components of the computing device. For example, the one or more busses 144 may include a power bus from the power source 150 to the various components of the computing device. Additionally, in some embodiments, the one or more busses 144 may include a dedicated bus among the one or more processors 142 and/or the memory 146.

The memory 146 may include any tangible, non-transitory, and computer-readable storage media. For example, the memory 146 may include volatile memory, non-volatile memory, or any combination thereof. For instance, the memory 206 may include read-only memory (ROM), randomly accessible memory (RAM), disk drives, solid state drives, external flash memory, or any combination thereof. Although shown as a single block in FIG. 2, the memory 146 can be implemented using multiple physical units in one or more physical locations. The one or more processor 202 accesses data in the memory 146 via the one or more busses 144.

The input structures 148 provide structures to input data and/or commands to the one or more processor 142. For example, the input structures 148 include a positional input device, such as a mouse, touchpad, touchscreen, and/or the like. The input structures 148 may also include a manual input, such as a keyboard and the like. These input structures 148 may be used to input data and/or commands to the one or more processors 142 via the one or more busses 144. The input structures 148 may alternative or additionally include other input devices. For example, the input structures 148 may include sensors or detectors that monitor the computing device 140 or an environment around the computing device 140. For example, a computing device 140 can contain a geospatial device, such as a global positioning system (GPS) location unit. The input structures 148 may also monitor operating conditions (e.g., temperatures) of various components of the computing device 140, such as the one or more processors 142.

The power source 150 can be any suitable source for power of the various components of the computing device 140. For example, the power source 150 may include line power and/or a battery source to provide power to the various components of the computing device 140 via the one or more busses 144.

The network interface 152 is also coupled to the processor 142 via the one or more busses 144. The network interface 152 includes one or more transceivers capable of communicating with other devices over one or more networks (e.g., the communication channel 106). The network interface may provide a wired network interface, such as Ethernet, or a wireless network interface, such an 802.11, Bluetooth, cellular (e.g., LTE), or other wireless connections. Moreover, the computing device 140 may communicate with other devices via the network interface 152 using one or more network protocols, such as Transmission Control Protocol/Internet Protocol (TCP/IP), power line communication (PLC), Wi-Fi, infrared, and/or other suitable protocols.

A user interface 154 may include a display that is configured to display images transferred to it from the one or more processors 142. In addition and/or alternative to the display, the user interface 154 may include other devices for interfacing with a user. For example, the user interface 154 may include lights (e.g., LEDs), speakers, and the like.

The discussion now turns to a mechanism for displaying system data, enabling interactivity with the system data, and reporting on the system data. FIG. 3 is a block diagram illustrating performance analytics and reporting (PAR) features facilitated through a homepage 170 and/or dashboard 172, in accordance with an embodiment. As used herein, a “homepage” refers to a graphical-user-interface (GUI) screen where data-driven widgets 174 may be placed in pre-defined containers 176 that have a static placement and/or size.

In some embodiments, it may be desirable to enable customized positioning and/or sizing of widgets 174. Accordingly, the dashboard 172 may be used to provide such features. As used herein, the term “dashboard” refers to a graphical-user-interface (GUI) screen where data-driven widgets 174 may be placed on the screen without being constrained to pre-defined containers 176 and/or static placement and/or size. In other words, for the dashboard 172, the widgets 174 may be dynamically moved to any location on the dashboard 172 without being constrained to pre-defined locations, as indicated by arrows 178. Further, the size of the widgets 174 may be dynamically altered in the dashboard 172, as indicated by sizing indicators 180 and arrows 182.

As there may be more flexibility in configuring a dashboard 172 over a homepage 170, it may be desirable in certain situations to convert a homepage 170 to a dashboard 172. Indeed, it may be burdensome to generate dashboards 172 from scratch after time and effort may have already been afforded to creating a homepage 170. Accordingly, in some embodiments, a conversion process 190 may be implemented to convert a homepage 170 to a dashboard 172.

The conversion process 190 may identify the widgets 174 found on the homepage 170 (block 192). For example, a computer-readable representation of the homepage 170 (e.g., a homepage object) may be traversed to identify each of the widgets 174 on the homepage 170.

Further, the conversion process 190 may identify the containers 176 and their associated sizes and placements for the identified widgets 174 found on the homepage 170 (block 194). For example, the computer-readable representation of the homepage 170 (e.g., a homepage object) may be traversed to identify each of containers 176 containing the widgets 174 on the homepage 170. Position and/or size attributes of the containers 176 may be identified by accessing object attributes of the computer-readable representation of the homepage 170.

Once the widgets 174 and the containers 176 and their attributes are identified. A corresponding dashboard 172 may be generated (block 196). For example, computer instructions may generate a computer-readable representation of the homepage 170, inserting the widgets 174 at the position and/or size identified by the container 176 attributes. Once the dashboard 172 is generated, it may be accessed and the size and position of the widgets 174 may be modified dynamically.

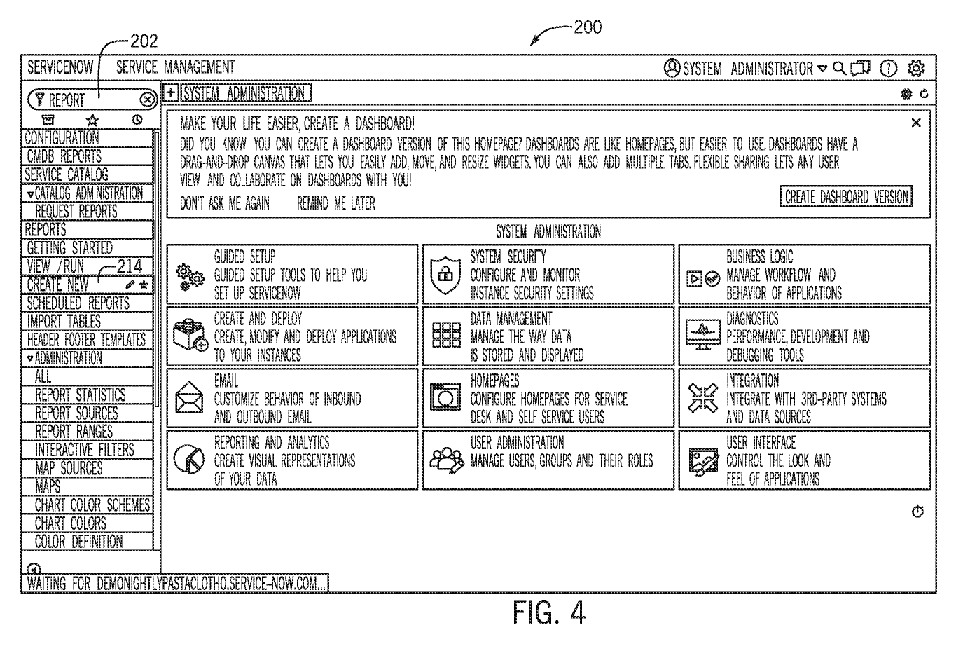

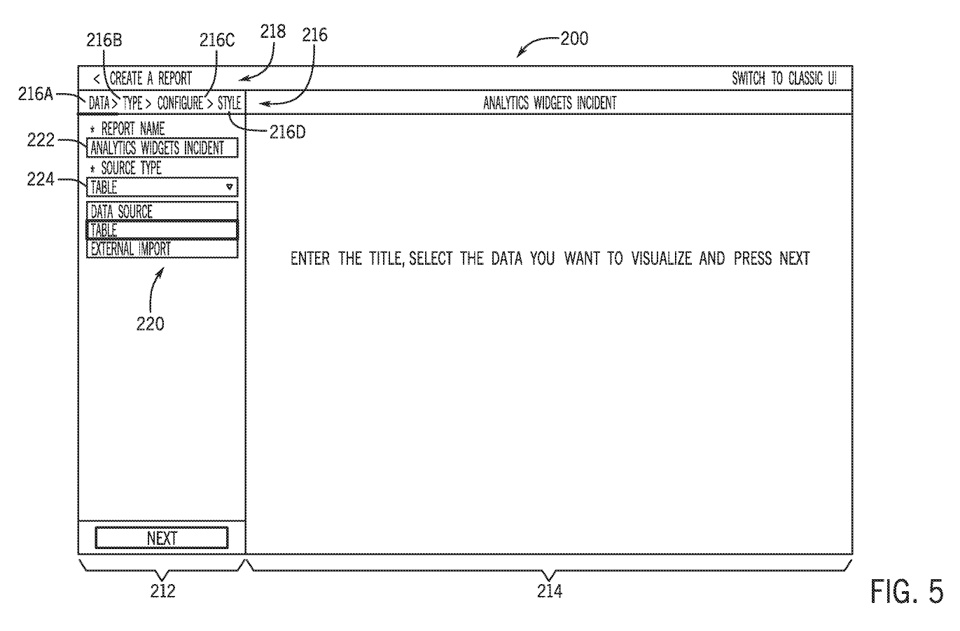

The widgets 174 may be independent data-driven software that perform particular tasks. For example, the widgets 174 may provide visualizations generated based upon datasets of the system, such as those present within database 112. In accordance with certain aspects of the present disclosure, the widgets 174 are generated according to a guided workflow presented as a part of a graphical user interface (GUI) 200, an example of which is illustrated in FIG. 4. The illustrated GUI 200 is configured to facilitate generation of analytics and/or reporting widgets on an embodiment of the homepage 170 or an embodiment of the dashboard 172.

The homepage 170 and/or dashboard 172 may, in certain embodiments, be displayed in a browser window of a browser application running on a particular computing device, such as a client device 102. The client device 102 may run the browser application for interaction with and display of the GUI 200, which is generated at the platform 104 side (e.g., by one or more of the instances 130 in the platform 104) of the system 100. However, the present techniques are not limited to such a configuration.

The GUI 200 includes various selectable inputs that cause the instance 130 to initiate the generation of certain types of reports, initiate analyses, perform diagnostics, and so forth. Among the selectable inputs is an action menu 202, which is divided into a plurality of categories including a “Reports” category having a “Create New” button 204 for creating a new report.

As illustrated in FIG. 5, the platform 104 (e.g., the instance 130) visually presents a widget creation application 210 via the GUI 200 in response to the “Create New” button 204 being selected. The illustrated embodiment of the widget creation application 210 presented via the GUI 200 includes a configuration section 212, and a data visualization section 214 presented separate from, but adjacent to the configuration section 212. Generally, attributes of the data visualization to be created by the widget creation application 210 are defined in the configuration section 212, while the data visualization itself is rendered within the data visualization section 214. Thus, the GUI 200 presents adjustable attributes associated with the data visualization in tandem with presenting the data visualization. This enables the GUI 200 to render the data visualization to demonstrate the effect of changing certain attributes of the data visualization as the widget 174 is being created.

A plurality of attribute buttons 216 are rendered within the configuration section 212 of the GUI 200, and are coupled with one another to define a guided widget creation workflow 218. In the illustrated embodiment, the plurality of attribute buttons 216 are presented in a horizontal arrangement in a manner that visually encourages a process flow. For example, the plurality of attribute buttons 216 are separated by arrows 220, which acts as a visual indication that one of the attribute buttons 216 should be addressed before another. However, in other embodiments, the plurality of attribute buttons 216 may be presented in other suitable arrangements, such as vertical, diagonal, circular, and so forth. Generally, the plurality of attribute buttons 216 are arranged such that more fundamental aspects of the widget 174 are defined first, followed by refinements of the widget 174. In accordance with certain embodiments, this layout is merely a guide—that is, the plurality of attribute buttons 216 may be addressed out of the presented order without disrupting the widget creation process. However, as shown, none of the attribute buttons 216 are available for selection other than “Data” button 216A. Thus, attributes associated with the data to be used for data visualization, in this embodiment, must first be defined before other attributes of the visualization may be manipulated or configured.

In the illustrated embodiment of the guided widget creation workflow 218, the plurality of attribute buttons 216 include, but are not necessarily limited to, a “Data” button 216A, a “Type” button 216B, a “Configure” button 216C, and a “Style” button 216D. Each of these buttons is described in further detail below in conjunction with a description of the guided widget creation workflow 218.

In accordance with present embodiments, the configuration section 212 also includes attribute input fields 220, with each of the attribute buttons 216 being associated with a particular set of attribute input fields 220. In the illustrated example, the “Data” button 216A is selected, and the platform 104 has caused the GUI 200 to display a particular set of attribute input fields 220 that are relevant to the data to be used in generating the widget 174. The attribute input fields 220 described herein may include any one or a combination of freeform text fields, drop-down menus, search-based entry fields, checkboxes, or any other suitable type of field for selection or entry of an attribute of the widget 174.

By way of non-limiting example, the attribute input fields 220 associated with the “Data” button 216A include a “Report name” field 222, which is a freeform field where a name of the widget can be specified (e.g., entered by typing). The attribute input fields 220 also include a “Source type” field 224, which is implemented as a drop-down menu. The Source type field 224 allows selection of the type of data to be accessed at the database 112 for generation of the data visualization. In this embodiment, the source types available for selection include “data source,” “table,” or “external import.”

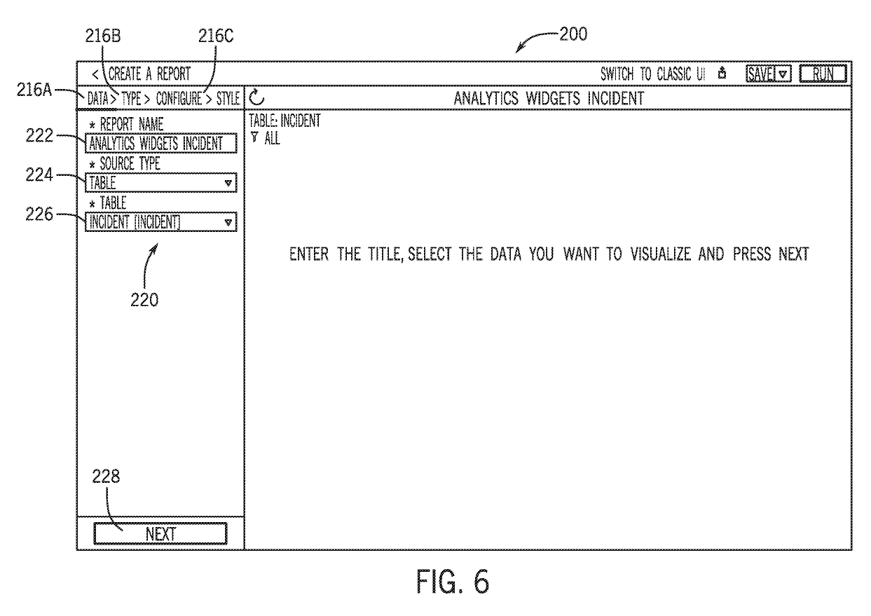

The attribute input fields 220 may be dynamically generated within the GUI 200. For example, moving from FIG. 5 to FIG. 6, it can be seen that the selection of “Table” in the Source type field 224 results in the display of another attribute field 220 that is specific to the table entry. Specifically, the attribute input fields 220 further include a “Table” field 226, implemented as a drop down menu, where selection of this field results in presentation of the tables available to use as the data to be visually represented in the widget 174. In the illustrated embodiment, the “Table” field 226 is populated with the selection “Incident,” meaning that the data to be used in generating the visualization in the widget 174 is a table having data relating to incidents.

As shown, the selections being provided in the attribute input fields 220 results in a “Next” button 228 being selectable. This means that the guided widget creation workflow 218 allows additional elements of the widget 174 to now be adjusted. For example, selection of the Next button 228 causes the GUI 200 to display the next step in the guided widget creation workflow 218. In the illustrated embodiment, this next step corresponds to the “Type” button 216B. However, it should also be noted that, having selected the source data to be used in rendering the visualization, the “Type” button 216B and the “Configure” button 216C are both selectable indicating that the type and configuration of the data visualization to be rendered can be manipulated once the source of the data has been selected.

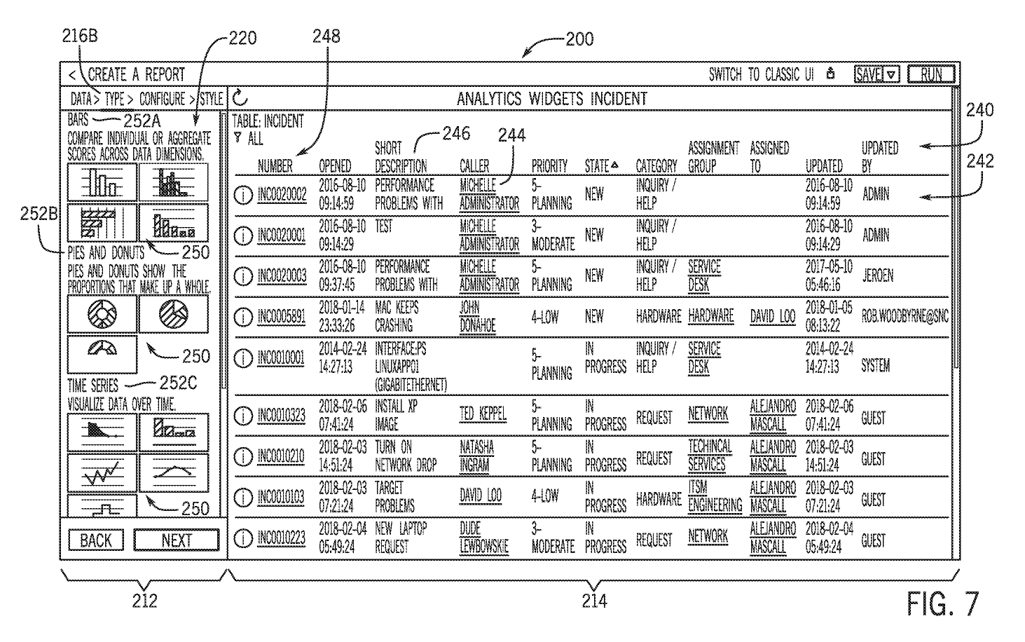

Moving now to FIG. 7, the “Type” button 216B portion of the guided widget creation workflow 218 is illustrated in a state before the type of visualization has been selected. However, as shown, the data visualization section 214 of the GUI 200 is displaying a table 240 corresponding to the “incident” table entered in the Table field 226 in FIG. 6. More specifically, the illustrated table 240 includes a plurality of data records 242 each relating to a particular incident. The data records 242 may represent all or a part of a data set stored on one or more of the databases 112 for one or more instances 110 associated with the client 102 (e.g., a managed network). The data records 242 include a plurality of data items 244, which may be individually selectable to access certain additional data associated with the data record 242. The table 240 also includes column headings 246 rendered within a header 248.

In the configuration section 212 of the GUI 200, the attribute input fields 220 now include different chart type buttons 250. The GUI 200 displays the different chart types using the data set in the table 240 within the data visualization section 214 in response to a particular chart type button 250 being selected. By way of non-limiting example, the GUI 200 in FIG. 7 depicts different chart type buttons 250 being associated with different chart types 252, including bar charts 252A, pie and donut charts 252B, and time series charts 252C. Each chart type button 250 is grouped with a similar chart type button 250 belonging to the same chart type 252, and includes an example visualization to aid in selection of a desired chart type for the widget 174.

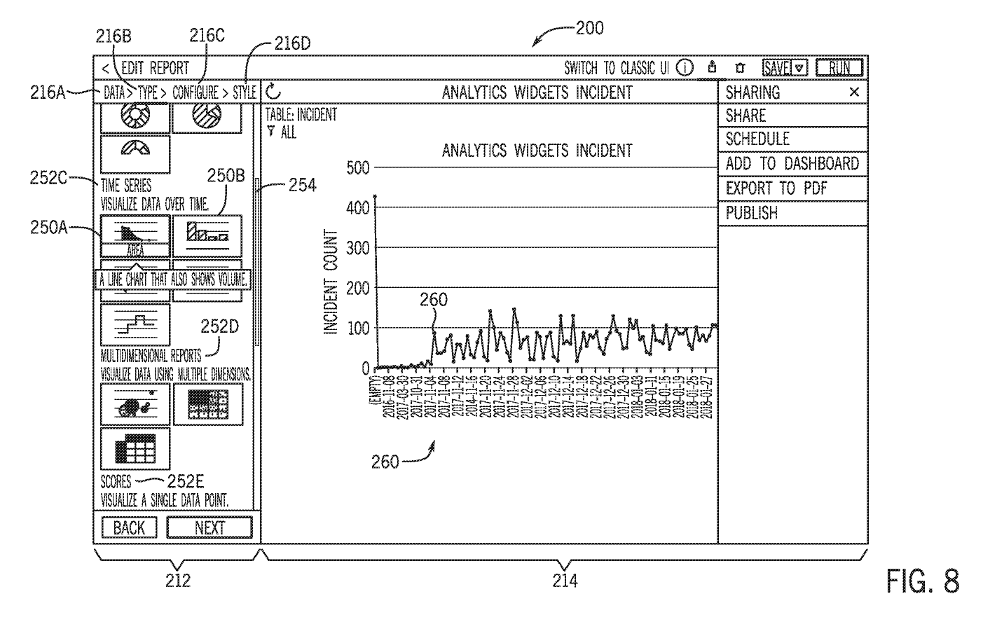

In the embodiment illustrated in FIG. 7, a scroll bar 254 separates the configuration section 212 from the data visualization section 214. The GUI 200 displays different chart types 252 in response to a scroll input via the scroll bar 254, as shown in FIG. 8. Specifically, FIG. 8 depicts an embodiment in which a time series chart 260 is displayed in the data visualization section 214 of the GUI 200, replacing the visualization of the table 240. For example, the time series chart 260 may be displayed upon selection of one of the chart type buttons 250 associated with the time series chart type 252. The time series chart 260 includes a plot of the number of total incidents as a function of time—specifically as a function of date (e.g., to illustrate the number of instances in a day). Thus, each data point 262 in the time series chart 260 represents a grouping or accumulation of data records 242 or data items 244 for that particular time point (e.g., a particular part of a day, a particular day, a particular week, and so on). That is, the time series chart 260 may be a graphical representation of a particular metric, where the particular metric may be an indicator as to how a managed network (e.g., the network 116 associated with the client 102) is performing, or other analytic data relating to the network 116. In certain embodiments the time series chart 260 may include a visualization of one or more key performance indicators (KPIs).

In FIG. 8, the configuration section 212 displays additional chart types 252 in response to a scroll input being performed on the scroll bar 254. The additional chart types shown include multidimensional reports 252D and scores 252E. The multidimensional reports 252D and scores 252E additionally allow data visualization in a different manner compared to the other chart types. In this embodiment, the multidimensional reports 252D display a visualization of the data in multiple dimensions, for example, to depict the data as a function of more than one variable. The scores 252E display a visualization of a single data point (e.g., a single data item 244 or a single data record 242).

As also shown in FIG. 8, the “Style” button 216D is selectable. Specifically, once a particular chart type is selected and rendered on the GUI 200, the guided widget creation workflow 218 provides an indication that the widget creation process can proceed to additional steps, including styling of the data visualization.

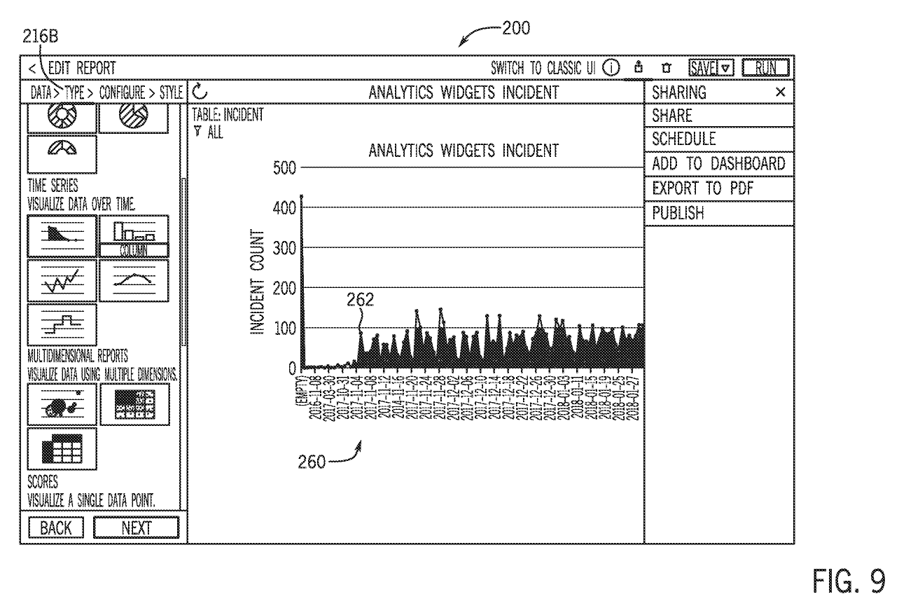

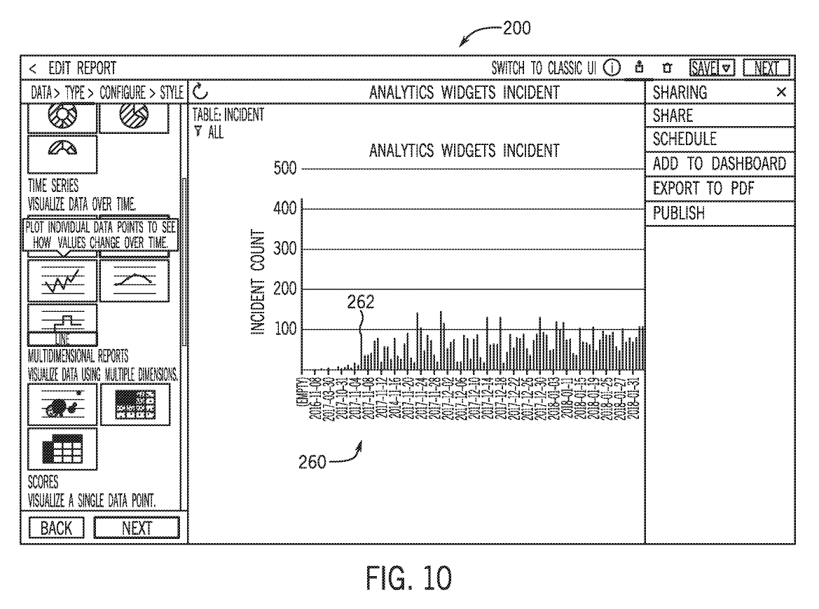

As noted above, the attribute input fields 220 may include different chart type buttons 250 being associated with the different chart types 252. FIGS. 9 and 10 depict examples where an area time series button 250A has been selected and a column time series button 250B has been selected, respectively. More specifically, FIG. 9 depicts the GUI 200 as displaying an area time series chart 260, in which the data points 262 are used to produce a line chart, with the area under the line being shaded to show volume. FIG. 10 depicts the GUI 200 as displaying a column time series chart 260 in which the data points 262 are not connected but the area under each point is shown.

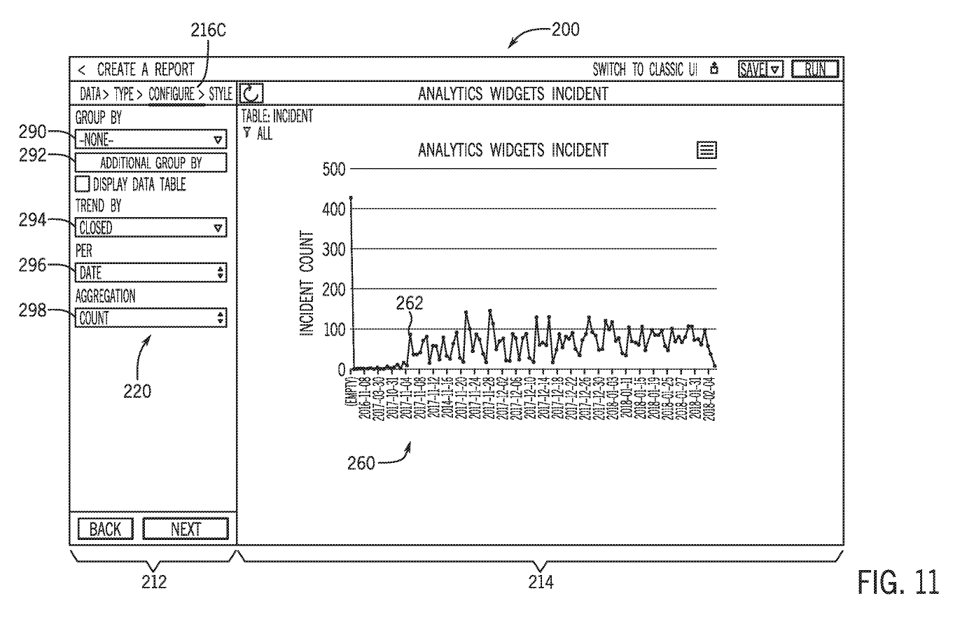

Various attributes of the data visualization (chart 260) are further manipulable via the attribute input fields 220 associated with the “Configure” button 216C, which is displayed as the step following the “Type” button 216B in the guided widget creation workflow 218. FIG. 11 depicts an embodiment of the GUI 200 in which the configuration section 212 includes attribute input fields 200 that relate to the “Configure” button 216C. The illustrated attribute input fields 220 include a “Group by” field 290, which causes the data points 262 of the chart 260 to be grouped according to, for example, a particular column heading 246 of the table 240. The attribute input fields 220 also include an “Additional group by” button 292 to cause the data points 262 to be grouped according to additional aspects of the data set.

The chart 260 can also be associated with a trend, which may be initiated in the GUI 200 via a “Trend by” field 294, implemented here as a drop down menu. Specifically, the chart 260 may be associated with a trend according to aspects of the data set that are selectable via a drop-down menu.

Because the data points 262 are depicted as a function of a variable associated with the data set of the table 240, the data points 262 may be visualized according to particular aspects of the variable (e.g., time). A “per” field 296 causes the data points 262 to be constructed by separating the data from the data set of the table 240 into groups according to some shared aspect of the data, such as common times or time periods (e.g., dates, weeks, months, and so forth).

The data points 262 may be further constructed by aggregating the data from the data set in the table 240. Thus, the attribute input fields 220 also include an “Aggregation” field 298, which causes the data to be aggregated according to a parameter relating, at least in part, to the “per” field 296 entry. For example, “Count” is shown as being entered into the aggregation field 298 (e.g., via a drop-down menu), meaning that the data is visualized by a “count” of the incidents per “date,” as entered in the “per” field 296.

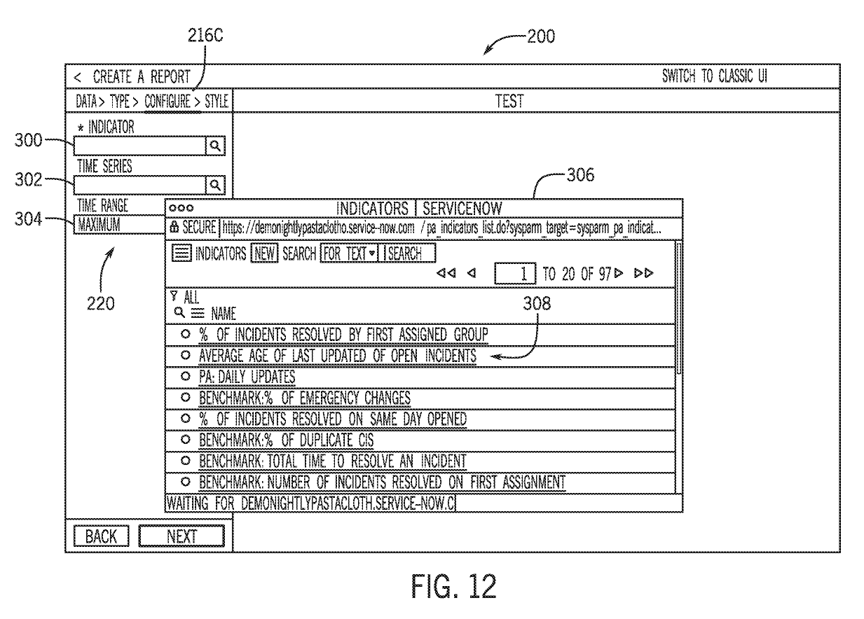

Another embodiment of the GUI 200 corresponding to a selection of the “Configure” button 216C is depicted in FIG. 12. In this example embodiment, the attribute input fields 220 include text-initiated search fields, including an indicator field 300, a time series field 302, and a time range field 304. In the depicted embodiment, the indicator field 300 is selected, which brings up a selection window 306 in the GUI 200. The selection window 306 provides a list of certain indicators 308, which may be key performance indicators (KPI) or other metrics associated with the network 116, for example. The time series field 302 and the time range field 304 may, when selected, cause similar selection windows to be shown on the GUI 200 for selection of time series parameters and time range parameters (e.g., the manner in which time series data points are grouped or separated and a time range for the data points to span).

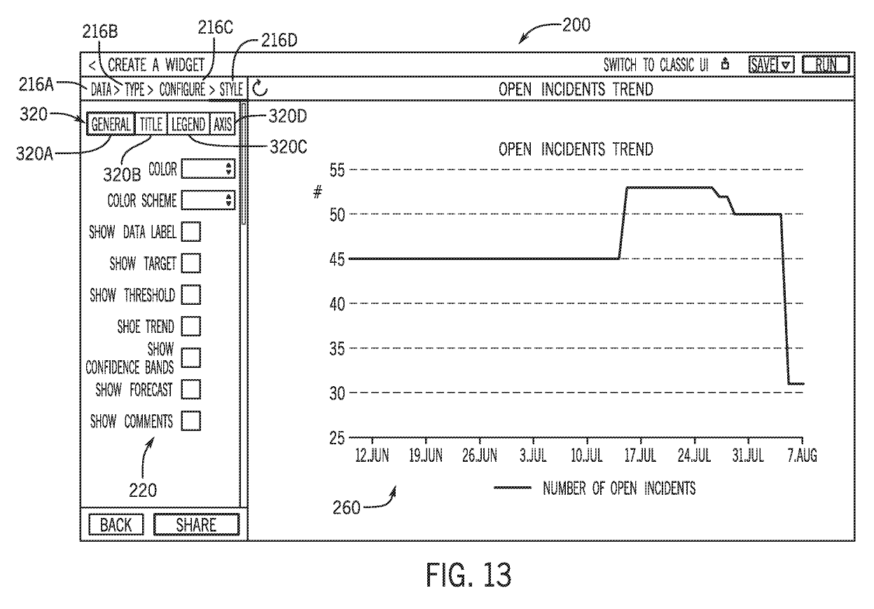

The next portion of the guided widget creation workflow 218 corresponds to the “Style” button 216D, which is shown in the GUI 200 of FIG. 13. The attribute input fields 220 for the “Style” button 216D generally adjust the appearance of the data visualization (e.g., chart 260), or information associated with the data visualization within the widget 174. The attribute input fields 220, in some embodiments, may be separated by sub-category buttons 320 to provide a more guided approach to adjusting the data visualization appearance. For example, as illustrated in FIG. 13, the attribute input fields 220 are divided in to a “General” button 320A, a “Title” button 320B, a “Legend” button 320C, and an “Axis” button 320D. The GUI 200 shown in FIG. 13 corresponds to the general button 320A being selected, which results in the GUI 200 presenting attribute input fields 220 including attributes relating to the overall appearance of the chart 260.

Example attribute input fields corresponding to the “General” button 320A include chart color, color scheme, a toggle to display data labels, a toggle to display a target, a toggle to display a threshold, a toggle to display a trend (e.g., the trend set forth in the “Configure” button 216C), a toggle to display confidence bands, a toggle to display a data forecast, and a toggle to display comments on the data. Other attribute input fields may include, by way of non-limiting example, an entry field for a custom chart size, a selectable menu for a preconfigured chart size (e.g., small, medium, large), a drilldown view field, and a decimal precision field.

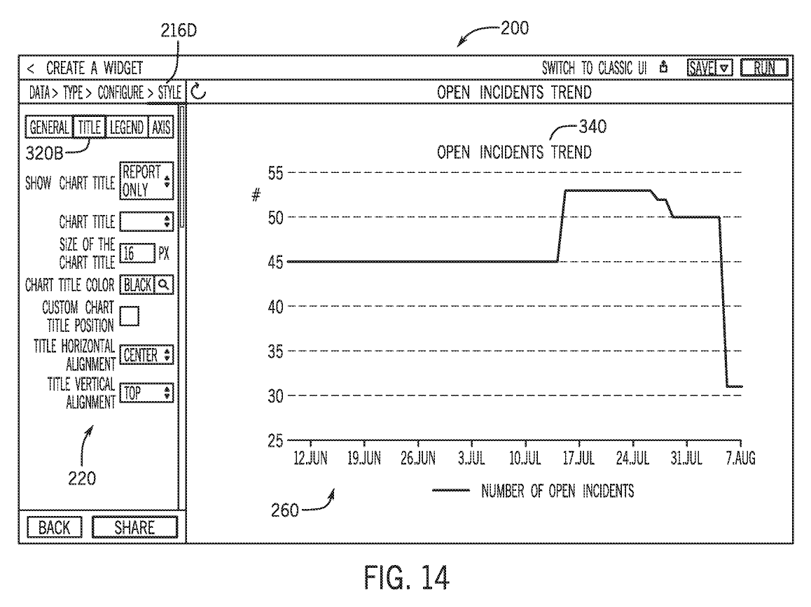

Selection of the “Title” button 320B, as in FIG. 14, results in other attribute input fields 220 displayed by the GUI 200 that relate to a title 340 of the data visualization. As shown, the attribute input fields 220 corresponding to the “Title” button 320B may include, by way of example, a toggle regarding whether to display the chart 260 only, or the title 340 in addition to the chart 260. The illustrated attribute input fields 220 also include a text entry field for the chart title, a text entry (or drop down selection menu) field to define the size of the chart title 340, a selection field for the chart title color, a toggle regarding whether to customize the position of the title 340 in relation to the chart 260, as well as fields for the horizontal and vertical alignment of the title 340.

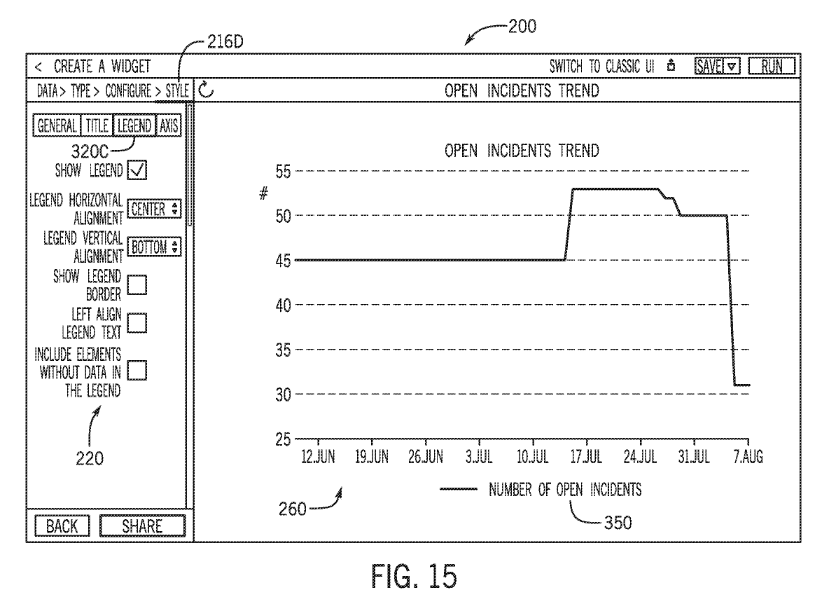

FIG. 15 depicts the GUI 200 when the “Legend” button 320C is selected. As depicted, the attribute input fields 220 for the “Legend” button 320C generally adjust aspects of a legend 350 corresponding to the chart 260. By way of non-limiting example, the attribute input fields 220 include a toggle regarding whether to show the legend 350, drop-down lists for horizontal and vertical alignment of the legend 350, a toggle for a border around the legend 350, a toggle for left alignment of the legend text, and a toggle to include elements without data in the legend 350.

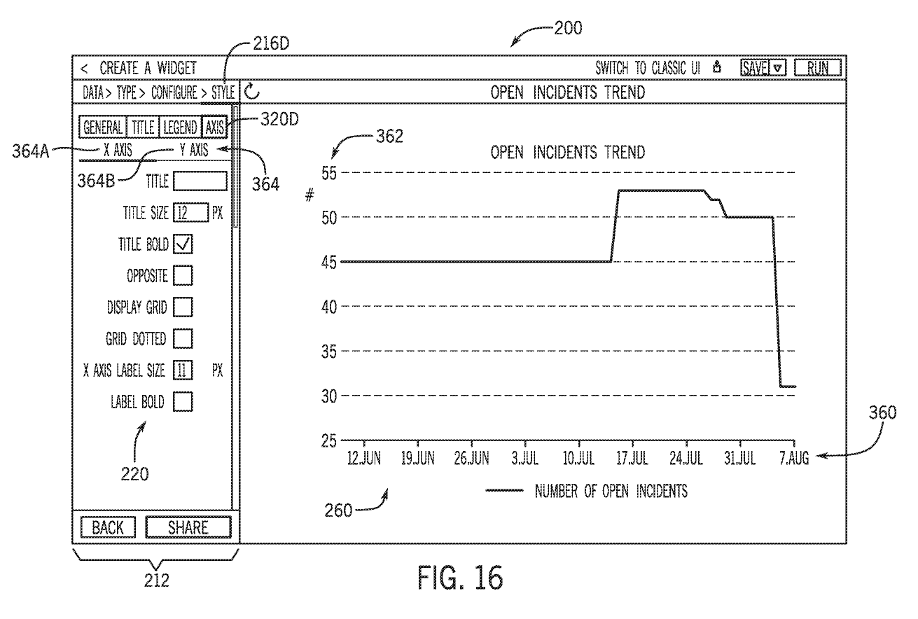

Moving now to selection of the “Axis” button 320D, FIG. 16 illustrates an embodiment of the GUI 200 where the attribute input fields 220 relate to the axes of the chart 260 (e.g., an X-axis 360 and a Y-axis 362). The configuration section 212 of the GUI 200 also includes further sub-category buttons 364 for the “Axis” button 320D, including an X-axis button 364A and a Y-axis button 364B. The sub-category buttons 364 enable individual customization for each of the axes of the chart 260. By way of non-limiting example, the attribute input fields 220 shown for the “Axis” button 320D include a title entry field for the respective axis, a title size for the respective axis, a toggle for whether to bold the title of the respective axis, a toggle for whether the respective axis should appear in an opposite direction, a toggle for a grid for the respective axis, a toggle for whether the grid should be dotted (or solid), a text entry (or drop-down selection) field for the label size for the respective axis, and a toggle for whether to bold the labels for the respective axis.

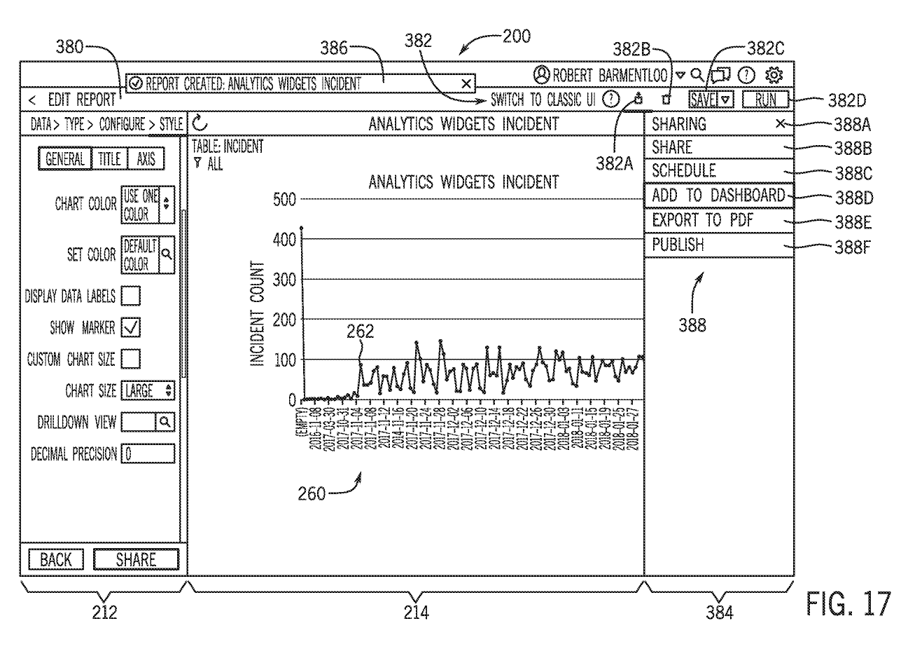

Once the data visualization (e.g., chart 260) is completed, various actions may be performed to finalize, create, and perform other actions with the widget 174. For example, as shown in FIG. 17, the GUI 200 includes a widget creation menu 380 that may include various menu items 382 to allow the widget 174 to be shared, saved, deleted, and so forth. Specifically, in the illustrated embodiment, the widget creation menu 380 includes a share indicator 382A that allows the widget 174 to be shared, a trash indicator 382B that causes the widget 174 to be deleted, a save indicator 382C that saves the widget 174, and a run button 382D, which runs the widget 174 (where appropriate).

As shown in FIG. 17, the GUI 200 displays a widget action section 384 (e.g., a widget action sidebar) in response to the share indicator 382A (or other indicator or button) being selected. In addition, the selection of the share indicator 382A also causes the report (the widget 174) to be created (as shown in a dialog box 386) and stored in the database 112 for the instance 110 associated with the client 102. In the widget action section 384, the GUI 200 displays various action items, here depicted as action buttons 388, which cause certain actions to be performed with the widget 174.

In the embodiment illustrated in FIG. 17, the action buttons 388 include a close button 388A, which when selected cancels the action to be performed with the widget 174 (here, the share action would be canceled). The action buttons 388 also include a share button 388B, which initiates a process for sharing the widget 174 with a recipient. A schedule button 388C initiates a scheduling process for the widget 174 (e.g., if the widget 174 is to periodically access data from the database 112). An add to dashboard button 388D initiates a process for adding the widget 174 to the dashboard 172 (or homepage 170). An export to PDF button 388E exports the widget 174 in PDF format, and a publish button 388F publishes the widget 174 so that the widget 174 is accessible by and/or insertable into various other applications (e.g., a presentation application).

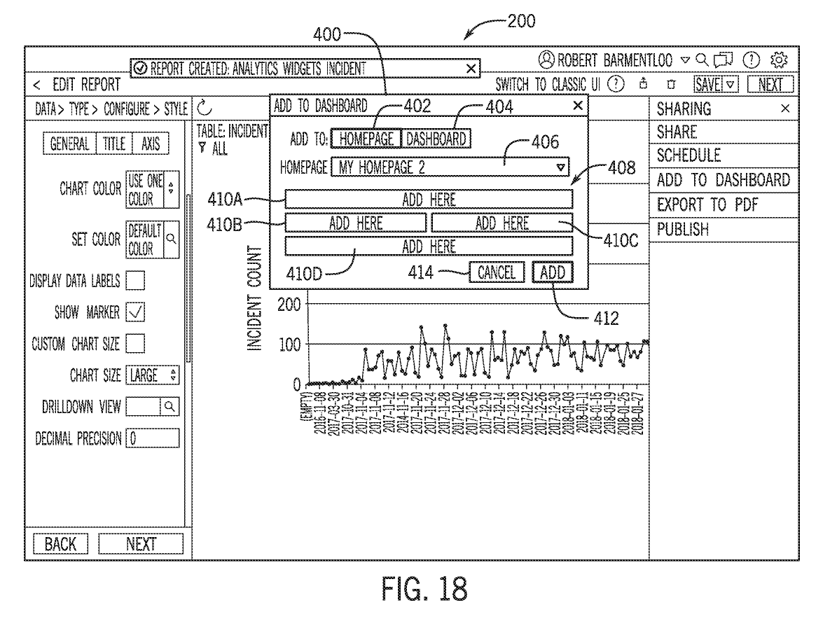

FIG. 18 depicts the GUI 200 in response to selection of the add to dashboard button 388D, where the GUI 200 displays an overlaid dialog box 400 with selectable homepage button 402 and a selectable dashboard button 404 to identify whether the widget 174 should be added to the homepage 170 or the dashboard 172, respectively. A drop-down selection field 406 is also presented in the dialog box 400 to enable selection of a particular homepage to which to add the widget 174.

The dialog box 400 also includes a layout representation 408 that represents the layout of the selected homepage 170 (or dashboard 172). The layout representation 408 is used as an indication for the location at the widget 174 should be added to the homepage 170 (or dashboard 172). For example, the location for adding the widget 174 may be defined via one of the illustrated positional “Add here” buttons 410A, B, C, or D). The addition is finalized via selection of the “Add” button 412 or is canceled via selection of the “Cancel” button 414.

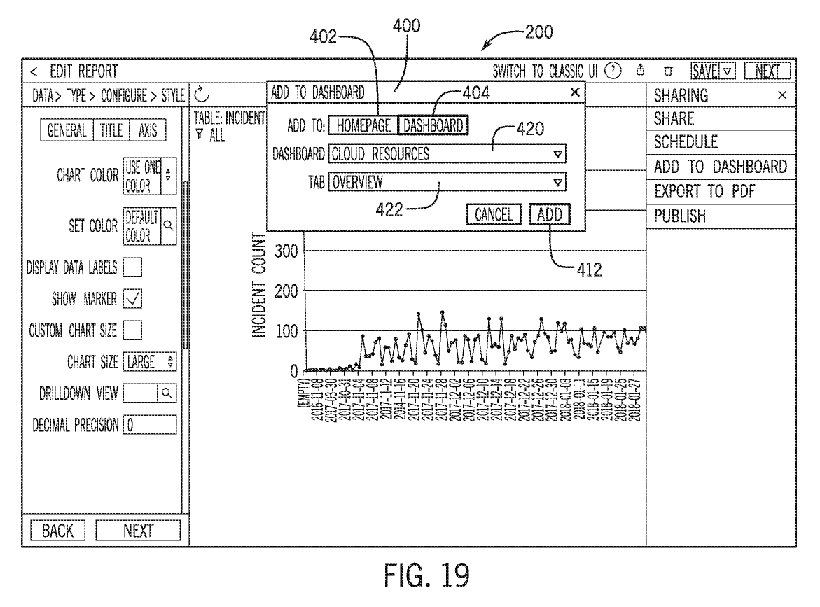

As set forth above, the dashboard 172 may be more flexible in its layout, sizing, and so forth, compared to the homepage 170. Accordingly, in certain embodiments, adding the widget 174 may be different than adding the widget 174 to the homepage 170, as shown in FIG. 19.

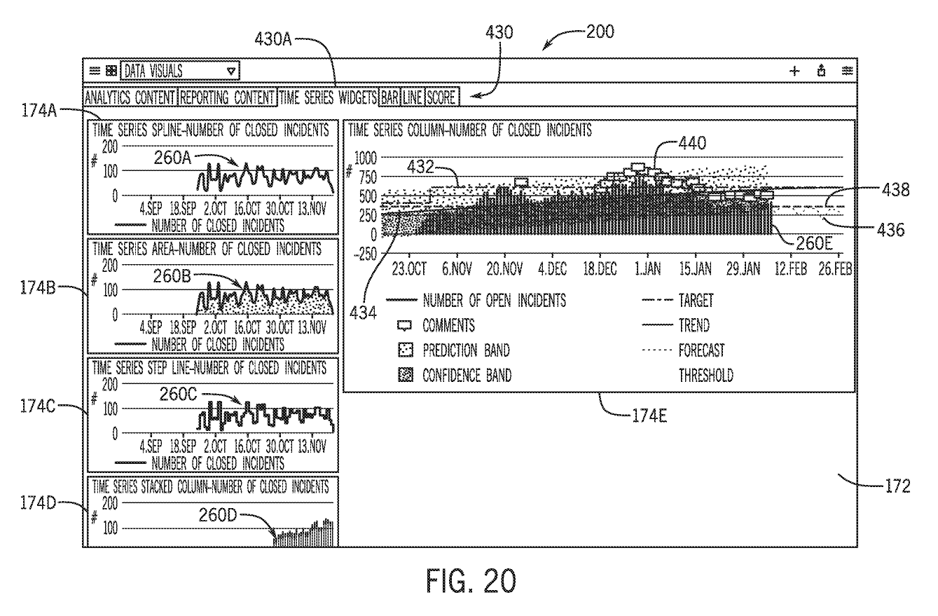

In FIG. 19, the dialog box 400 is shown with the “Dashboard” button 404 selected. Here, the dialog box 400 includes a dashboard selection field 420 for selection of a particular dashboard 172 from a drop-down list. Each dashboard 172 may also have a number of different tabs (see, e.g., FIG. 20), and the dialog box 400 further includes a tab selection field 422 for selection of a particular tab within the dashboard 172 from a drop-down list. Once the tab is selected, the “Add” button 412 may be selected to add the widget 174 to the particular tab within the particular dashboard 172. Further, in some embodiments, the layout representation 408 may be provided to allow positioning of the widget 174 within the tab.

An embodiment of the dashboard 172 is depicted in FIG. 20, with a plurality of widgets 174 produced according to present embodiments being included on one of a plurality of available tabs 430. In particular, the illustrated dashboard 172 includes a “Time-Series widgets” tab 430A, which is selected to show a plurality of time-series widgets 174. The time-series widgets 174 include a time series spline widget 174A, which depicts a spline chart 260A of the number of closed incidents as a function of date.

The time-series widgets 174 also include a time series area widget 174B, which depicts an area chart 260B of a number of closed incidents as a function of date. A time series step line widget 174C depicts a number of closed incidents as a function of date in a step line chart 260C. A time series stacked column widget 174D depicts a stacked column chart 260D of a number of closed incidents as a function of date. The columns in the stacked column chart 260D may be stacked to display, for example, a change in the number of closed incidents for a particular date.

A time series column widget 174E is also shown as including several features that can be incorporated into the widgets 174 described herein, including features that facilitate visualization of metrics and/or KPIs. Specifically, the time series column widget 174E includes a time series column chart 260E of closed incidents as a function of date. The time series column widget 174E also includes a target band 432, which provides a visualization of a target number of closed incidents as a function of date. The target band 432 may be user-defined, or may be user-defined as a function of the number of open incidents at a given date.

The time series column widget 174E further includes a trend line 434 to demonstrate the manner in which the data (e.g., closed incidents) trends over the range of dates (e.g., over time). A forecast line 436 depicts how the closed incidents are forecast to show in the chart 260E at future dates. A threshold line 438 provides a performance indicator visualization relating to the management of the managed network. A prediction band 440 provides another performance indicator visualization as to how the number of closed incidents was predicted to trend at a particular date.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A system configured to create analytics widgets in a guided widget creation workflow, wherein the system is associated with a computational instance of a remote platform that remotely manages a managed network, the system comprising:
a database containing analytics data associated with the managed network, the analytics data defining indicators or metrics; and
wherein the remote platform is configured to present a portion of the computational instance on a graphical user interface (GUI) via a display connected to a computing device having access to the computational instance, and wherein the portion of the computational instance displayed via the GUI comprises a widget creation process configured to create the analytics widgets each having a data visualization using the analytics data and the indicators or metrics from the database, and wherein the widget creation process is configured to:
cause a first section of the GUI rendered on the display to include a plurality of buttons coupled with one another to define the guided widget creation workflow, and wherein each button of the plurality of buttons is configured to cause a respective set of attribute input fields to be displayed in response to a selection input, the respective set of attribute input fields being configured to receive user inputs to specify attributes associated with the data visualization; and
cause a second section of the GUI rendered on the display proximate to the first section to present the data visualization in response to inputs received via the guided widget creation workflow.

2. The system of claim 1, wherein the plurality of buttons are rendered adjacent one another in a horizontal row, and are separated by arrows to encourage selection inputs to be made sequentially along the horizontal row.

3. The system of claim 1, wherein the plurality of buttons comprise a first button and a second button, wherein the second button is not selectable until a threshold set of attributes are received via the respective set of attribute input fields associated with the first button.

4. The system of claim 3, wherein the respective set of attribute input fields associated with the first button specify a source or a type, or both, of the analytics data used for the data visualization.

5. The system of claim 3, wherein at least one attribute field of the respective set of attribute input fields associated with the first button comprises a drop-down menu configured to present a list of selectable types of analytics data in response to selection input.

6. The system of claim 5, wherein the widget creation process is configured to cause the first section of the GUI to display at least one new attribute field in response to a selection of a type of analytics data from the list of selectable types of analytics data, wherein the at least one new attribute field relates to the type of analytics data.

7. The system of claim 3, wherein the respective set of attribute input fields associated with the second button specify a type of data visualization.

8. The system of claim 7, wherein the respective set of attribute input fields associated with the second button comprises a plurality of chart type buttons, each chart type button including an example visualization.

9. The system of claim 1, wherein the GUI includes an action menu, wherein the action menu includes a reports category configured to initiate the widget creation process in response to one or more selection inputs.

10. The system of claim 1, wherein the GUI is generated by the remote platform for display in a browser window using a browser application run on the computing device.

11. The system of claim 1, wherein the set of attribute input fields include any one or a combination of freeform text fields, drop-down lists, search-based entry fields, or checkboxes.

12. The system of claim 1, wherein at least one of the buttons of the plurality of buttons has a respective set of attribute input fields configured to adjust styling of the data visualization.

13. The system of claim 1, wherein at least one of the buttons of the plurality of buttons has a respective set of attribute input fields configured to adjust grouping of analytics data used for the data visualization.

14. The system of claim 1, wherein the widget creation process is configured to present the analytics data used for the data visualization in the second section of the GUI in response to a selection of a data source using a button of the plurality of buttons and its respective set of attribute input fields, and to replace the analytics data with the data visualization in response to a chart type selection using another button of the plurality of buttons and its respective set of attribute fields.

15. A method of creating analytics widgets in a guided widget creation workflow, wherein the method is performed using a system associated with a computational instance of a remote platform that remotely manages a managed network, the method comprising:
presenting a portion of the computational instance on a graphical user interface (GUI) via a display connected to a computing device having access to the computational instance, the portion of the computational instance having a widget creation process associated therewith; and
performing the widget creation process via the GUI using analytics data associated with the managed network accessed from a database, the analytics data defining indicators or metrics, and wherein the widget creation process comprises:
causing a first section of the GUI rendered on the display to include a plurality of buttons coupled with one another to define the guided widget creation workflow, and wherein each button of the plurality of buttons is configured to cause a respective set of attribute input fields to be displayed in response to a selection input, the respective set of attribute input fields being configured to receive user inputs to specify attributes associated with a data visualization generated using the indicators or metrics; and
causing a second section of the GUI rendered on the display proximate to the first section to present the data visualization in response to inputs received via the guided widget creation workflow.

16. The method of claim 15, wherein the plurality of buttons comprise a first button and a second button, wherein the second button is not selectable until a threshold set of attributes are received via the respective set of attribute input fields associated with the first button.

17. The method of claim 16, wherein the respective set of attribute input fields associated with the first button specify a source or a type, or both, of the analytics data used for the data visualization, and wherein at least one attribute field of the respective set of attribute input fields associated with the first button comprises a drop-down menu configured to present a list of selectable types of analytics data in response to selection input.

18. The method of claim 17, wherein the widget creation process comprises causing the first section of the GUI to display at least one new attribute field in response to a selection of a type of analytics data from the list of selectable types of analytics data, wherein the at least one new attribute field relates to the type of analytics data.

19. The method of claim 16, wherein the respective set of attribute input fields associated with the second button specify a type of data visualization, and wherein the respective set of attribute input fields associated with the second button comprises a plurality of chart type buttons, each chart type button including an example visualization.

20. A tangible, non-transitory, machine-readable medium, comprising machine-readable instructions, configured to:
present a portion of a computational instance on a graphical user interface (GUI) via a display connected to a computing device having access to the computational instance, the portion of the computational instance having a widget creation process associated therewith; and
perform the widget creation process via the GUI using analytics data associated with a managed network accessed from a database, the analytics data defining indicators or metrics, and wherein the widget creation process comprises:
causing a first section of the GUI rendered on the display to include a plurality of buttons coupled with one another to define the guided widget creation workflow, and wherein each button of the plurality of buttons is configured to cause a respective set of attribute input fields to be displayed in response to a selection input, the respective set of attribute input fields being configured to receive user inputs to specify attributes associated with a data visualization generated using the indicators or metrics; and
causing a second section of the GUI rendered on the display proximate to the first section to present the data visualization in response to inputs received via the guided widget creation workflow.
